(19) United States
(12) Patent Application Publication
(10) Pub. No.: US 2012/0049105 A1
(43) Pub. Date: Mar. 1, 2012

(54) COMPOSITION WITH HEAT DISSIPATION PERFORMANCE OF CERAMICS

(76) Inventors: CHUN-CHING HSIAO, Taipei City (TW); Chiang-Chung Chang, Taipei City (TW)

(21) Appl. No.: 13/214,239

(22) Filed: Aug. 22, 2011

(30) Foreign Application Priority Data
Aug. 26, 2010 (TW) 099128685

(51) Int. Cl. C09K 5/00

(52) U.S. Cl. 252/71

(57) ABSTRACT

A composition with heat dissipation performance of ceramics includes ceramic particles that take a weight percentage of substantially 25%-90% of the composition, have a particle size substantially between 10-50 μm, and thermal conductivity λ≧25 W/m·K, the ceramic particles being subjected to surface activation treatment; and metal particles that take a weight percentage of substantially 75%-10% of the composition and have thermal conductivity λ≧50 W/m·K. The ceramic particles and the metal particles are subjected to heating under a non-oxidizing environment to a temperature greater than the melting point of the metal but below the melting point of the ceramic particles, so that the metal is molten to form a metal melt that surrounds and bonds the ceramic particles, and then pouring and casting are performed in a non-oxidizing environment. As such, the metal that possesses excellent thermal conduction capability is also imposed with excellent thermal radiation capability of the ceramics.

### (a) TECHNICAL FIELD OF THE INVENTION

The present invention generally relates to a composition with heat dissipation performance of ceramics, which is a novel composition that enhances heat dissipation performance.

### (b) DESCRIPTION OF THE PRIOR ART

An element that generates heat during the operation thereof, such as a computer central processing unit (CPU) or a circuit board carrying high brightness light-emitting diodes (LEDs), requires a heat dissipater with excellent performance in order to maintain normal operation within an extended period of lifespan. Conventionally, such a heat generating element that generates heat during the operation thereof is often provided, in a manner of being stacked on a back surface of the element, with a heat dissipater that is generally completely made of metal, such as a copper based heat dissipation board and an aluminum based heat dissipation board, in order to conduct off and dissipate the heat generated by the heat generating element.

With such a heat generating element being evolved and getting more powerful, the amount of heat generated in substantially increased, making the conventional heat dissipater impractical and incapable of handling the desired performance of heat dissipation. Thus, an enhanced heat dissipater that is more powerful must be developed and provided.

In view of the performance of heat dissipation with the conventional heat dissipater that shows the above discussed deficiency, the present invention aims to overcome such a deficiency.

### SUMMARY OF THE INVENTION

The present invention provides a composition with heat dissipation performance of ceramics that is intended to serve as an enhanced heat dissipation measure that shows enhanced heat dissipation efficiency. The composition comprises the following components:

ceramic particles that take a weight percentage of substantially 25%-90% of the composition, have a particle size substantially between 10-50 μm, and thermal conductivity λ≧25 W/m·K (in which λ stands for thermal conductivity, “W” is watt, “m” is meter, “·” represents multiplication, and “K” is absolute temperature), the ceramic particles being subjected to surface activation treatment; and metal particles that take a weight percentage of substantially 75%-10% of the composition and have thermal conductivity λ≧50 W/m·K.

The ceramic particles and the metal particles are subjected to heating under a non-oxidizing environment to a temperature greater than the melting point of the metal (around 500-1,290° C.) but below the melting point of the ceramic particles (the melting point of ceramics being higher than a single metal), so that the metal is molten to form a metal melt that surrounds and bonds the ceramic particles, and then pouring and casting are performed in a non-oxidizing environment (which is anaerobic chamber that provides an environment that is vacuum through air evacuation or that is filled with inert gas). As such, through selection of ceramic material that is of high thermal conductivity, due to the thermal radiation capability of the high thermal conductivity ceramic material being superior to that of metal (metals being good for heat dissipation through thermal conduction, but has a poor capability of heat dissipation through thermal radiation), and as indicated in the plot of average thermal radiation performances shown in FIG. 1 that ceramic materials have an average thermal radiation range (reference numeral 10) of around 0.4-0.8 e, which is superior to metal oxides that have an average thermal radiation range (reference numeral 20) of around 0.25-0.65 e, non-polished metals that have an average thermal radiation range (reference numeral 30) of around 0.1-0.4 e, and polished metals that have an average thermal radiation range (reference numeral 40) of around 0.025-0.19 e, the composition as a whole show high performance of heat dissipation through both thermal conduction and thermal radiation, so that the overall heat dissipation performance is far better than any heat dissipater purely made of metals. This is the primary objective of the present invention.

Further, the composition with heat dissipation performance of ceramics according to the present invention is formed by heating the metal particles to form a metal melt that surrounds and bonds the ceramic particles, followed by an operation of pouring and casting so as to show a surface in contact with the surrounding atmosphere that presents a distribution of projecting top ends of the ceramic particles that are of irregular projecting heights thereby improving minor heat dissipation capability of heat convection H3 on the surface and thus providing an enlarged heat dissipation surface that improves dissipation of heat. This is an additional objective of the present invention.

Further, heretofore, to shape a ceramic material in a desired size and configuration, heating at a temperature around or greater than approximately 1,500° C. is applied to melt the ceramic material in order to shape the ceramic material. Besides the great expense required for generating such a high temperature, such a conventional process is not environment-friendly due to high temperature melting, high consumption of energy, and generation of great amount of carbon dioxide. On the other hand, the composition with heat dissipation performance according to the present invention applies a surface activation treatment to process surfaces of the ceramic particles so that the ceramic particles can be well bonded with the metal melt that is formed through heating under a low temperature environment of 500-1,290° C., in which the ceramics are not molten, but the metal is molten, whereby the overall heat dissipation performance can be improved, but the overall physical strength is not improperly affected. Compared to the conventional way of heating and melting ceramic materials at a temperature around or higher than 1,500° C., the present invention offers a solution that can be obtained at a lower heating temperature and thus reducing energy consumption and being environment-friendly. This is a further important objective of the present invention.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a plot showing comparison of thermal radiation among different materials.

FIG. 2 is a schematic view illustrating the structure of and heat dissipation realized with a composition with heat dissipation performance of ceramics according to the present invention.

FIG. 3 shows plots of heat dissipation effect and strength for a composite of copper alloy and ceramic material that constitute an example of the composition of the present invention.

FIG. 4 shows plots of heat dissipation effect and strength for a composite of zinc alloy and ceramic material that constitute an example of the composition of the present invention.

FIG. 5 shows plots of heat dissipation effect and strength for a composite of aluminum alloy and ceramic material that constitute an example of the composition of the present invention.

FIG. 6 shows plots of heat dissipation effect and strength for a composite of magnesium alloy and ceramic material that constitute an example of the composition of the present invention.

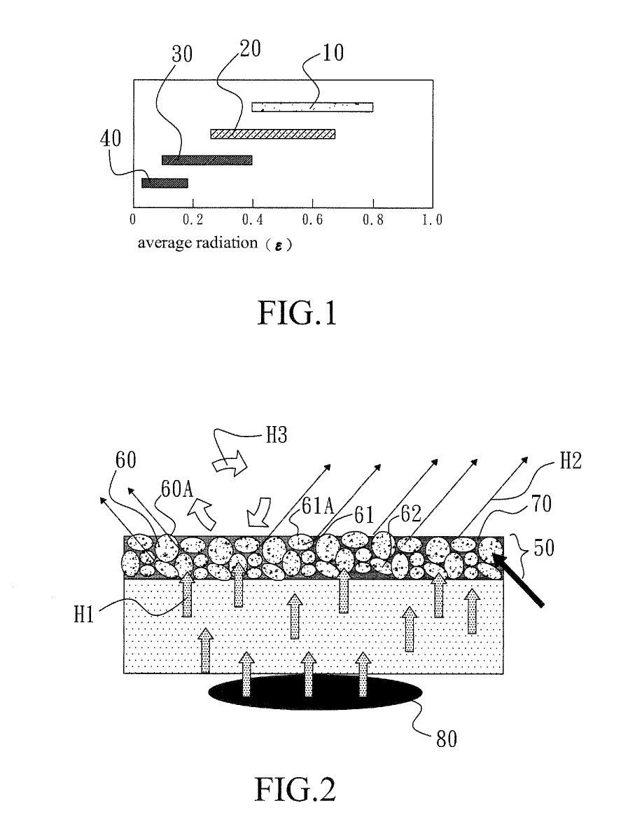

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

FIG. 2 is a schematic view illustrating the structure of and heat dissipation realized with a composition with heat dissipation performance of ceramics according to the present invention. The drawing shows that the composition with heat dissipation performance of ceramics according to the present invention, generally designated at 50, is formed by using a proper amount of metal 70 that is heated to present a liquid metal melt to surround and bond a proper amount of ceramic particles 60, 61, 62. The ceramic particles 60, 61, 62 are subjected, in advance, to surface activation treatment so that the ceramic particles 60, 61, 62 that are in a granular form can show excellent bond with the metal 70 under a heated condition, whereby besides the excellent capability of thermal conduction H1 possessed by the metal 70, due to the ceramic particles 60, 61, 62 so surrounded, the capability of heat radiation H2 is improved. Further, the metal 70 that is formed by heating and melting metal particles into a metal melt to surround and bond the ceramic particles 60, 61 is subjected to pouring and casting to show a surface in contact with the surrounding atmosphere that presents a distribution of projecting top ends 60A, 61A of the ceramic particles that are of irregular projecting heights so as to provide minor heat dissipation capability of heat convection H3 on the surface thereby providing an enlarged heat dissipation surface that improves dissipation of heat from a heat source 80.

A suitable ratio between the ceramic particles 60, 61, 62 and the metal 70 is determined through a compromise between statistical curves of the conductivity coefficient of metal for the resultant amounts of metal used in respect of different weight percentages of the ceramic particles 60, 61, 62 added and the tensile strength of the metal so used, an intersection zone of the curves within which both the conductivity and tensile strength are acceptable is selected as a suitable ratio zone for the ceramic particles 60, 61, 62 and the metal 70. The tensile strength of the metal is better kept above 100 Mpa for not being easily damaged and showing a desired commercial value. The heat dissipation coefficient h is better kept above 0.4 h for acceptable commercial value.

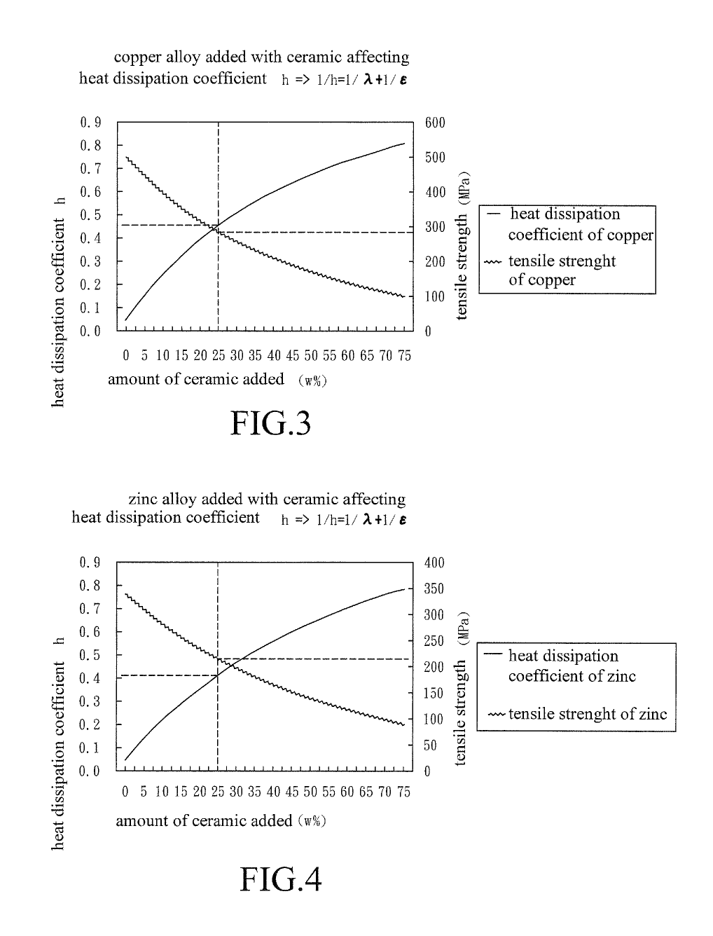

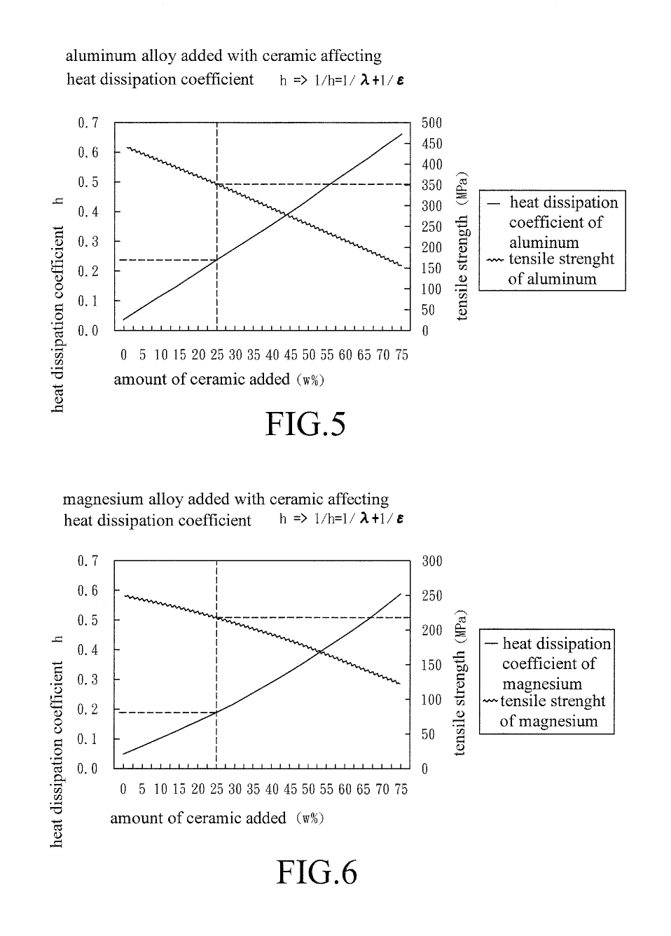

Experiments are repeated performed to obtain for example plots of heat dissipation effect and strength for a composite of copper alloy and ceramic material that are shown in FIG. 3, plots of heat dissipation effect and strength for a composite of zinc alloy and ceramic material that are shown in FIG. 4, plots of heat dissipation effect and strength for a composite of aluminum alloy and ceramic material that are shown in FIG. 5, and plots of heat dissipation effect and strength for a composite of magnesium alloy and ceramic material that are shown in FIG. 6. These plots indicate that for an added amount of ceramic material exceeding a range of 30-60 w %, the heat dissipation performance can be significantly improved, and the strength is still kept above around 100 MPa, showing a practical commercial value.

Through further selection, the ceramic particles are preferably of a particle diameter between 10-50 μm and thermal conductivity λ≧25 W/m·K take weight percentage of 25%-90% of the total weight of the composition, while the metal particles preferably showing thermal conductivity λ≧50 W/m·K take weight percentage of 75%40% of the whole composition to provide a sufficient heat dissipation coefficient of the metal and also have a sufficient tensile strength of the metal. The metal that can be used in the present invention, besides being alloys of copper, zinc, aluminum, and magnesium as shown in FIGS. 3-6, can also be tin. Further, the ceramic particles 60, 61, 62 can be silicon carbide, aluminum nitride, zinc oxide, aluminum oxide, or graphite.

After the selection of the ceramic particles that take a weight percentage of 25%-90% of the whole composition, have a particle size between 10-50 μm and thermal conductivity λ≧25 W/m·K and the metal particles that take a weight percentage of 75%-10% of the whole composition and has a thermal conductivity λ≧50 W/m·K, the ceramic particles and the metal particles are then subjected to heating under a non-oxidizing environment to a temperature greater than the melting point of the metal but below the melting point of the ceramic particles, so that the metal is molten to form a metal melt that surrounds and bonds the ceramic particles, and then pouring and casting are performed in a non-oxidizing environment.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A composition with heat dissipation performance of ceramics, comprising:
ceramic particles that take a weight percentage of substantially 25%-90% of the composition, have a particle size substantially between 10-50 μm, and thermal conductivity λ≧25 W/m·K, the ceramic particles being subjected to surface activation treatment; and
metal particles that take a weight percentage of substantially 75%-10% of the composition and have thermal conductivity λ≧50 W/m·K;
wherein the ceramic particles and the metal particles are subjected to heating under a non-oxidizing environment to a temperature greater than the melting point of the metal but below the melting point of the ceramic particles, so that the metal is molten to form a metal melt that surrounds and bonds the ceramic particles, and then pouring and casting are performed in a non-oxidizing environment.

2. The composition according to claim 1, wherein the ceramic particles, which take a weight percentage of substantially 25%-90% of the composition, have a particle size substantially between 10-50 μm, and thermal conductivity λ≧25 W/m·K and is subjected to surface activation treatment comprises silicon carbide.

3. The composition according to claim 1, wherein the ceramic particles, which take a weight percentage of substantially 25%-90% of the composition, have a particle size substantially between 10-50 μm, and thermal conductivity λ≧25 W/m·K and is subjected to surface activation treatment comprises aluminum nitride.

4. The composition according to claim 1, wherein the ceramic particles, which take a weight percentage of substantially 25%-90% of the composition, have a particle size substantially between 10-50 μm, and thermal conductivity λ≧25 W/m·K and is subjected to surface activation treatment comprises zinc oxide.

5. The composition according to claim 1, wherein the ceramic particles, which take a weight percentage of substantially 25%-90% of the composition, have a particle size substantially between 10-50 μm, and thermal conductivity λ≧25 W/m·K and is subjected to surface activation treatment comprises aluminum oxide.

6. The composition according to claim 1, wherein the ceramic particles, which take a weight percentage of substantially 25%-90% of the composition, have a particle size substantially between 10-5 μm, and thermal conductivity λ≧25 W/m·K and is subjected to surface activation treatment comprises graphite.

7. The composition according to claim 1, wherein the metal particles, which take a weight percentage of substantially 75%-10% of the composition and have thermal conductivity λ≧50 W/m·K comprises aluminum.

8. The composition according to claim 1, wherein the metal particles, which take a weight percentage of substantially 75%-10% of the composition and have thermal conductivity λ≧50 W/m·K comprises magnesium.

9. The composition according to claim 1, wherein the metal particles, which take a weight percentage of substantially 75%-10% of the composition and have thermal conductivity λ≧50 W/m·K comprises tin.

10. The composition according to claim 1, wherein the metal particles, which take a weight percentage of substantially 75%-10% of the composition and have thermal conductivity λ≧50 W/m·K comprises copper.

11. The composition according to claim 1, wherein the metal particles, which take a weight percentage of substantially 75%-10% of the composition and have thermal conductivity λ≧50 W/m·K comprises zinc.
